(19) United States
(12) Patent Application Publication
(10) Pub. No.: US 2024/0116464 A1
(43) Pub. Date: Apr. 11, 2024

(54) CLAMP AND WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Keitaro OGI, Osaka (JP)

(21) Appl. No.: 18/271,824

(22) PCT Filed: Jan. 18, 2022
(86) PCT No.: PCT/JP2022/001505

§ 371 Date: Jul. 11, 2023

(30) Foreign Application Priority Data
Jan. 19, 2021 (JP) 2021-006370

(51) Int. Cl. B60R 16/02; H02G 3/32

(52) U.S. Cl. CPC B60R 16/0215; H02G 3/32

(57) ABSTRACT

A clamp (10) according to one aspect of the present disclosure, which secures an electric wire (5) to an attachment target such as a vehicle door, comprises a secured part (13) secured to an attachment target such as a body and a holding part (14) that holds the electric wire (5) in a selected position along the height of the secured part (13). The clamp (10) comprises a height adjustment mechanism (15) that attaches the holding part (14) to the secured part (13) such that the position of the holding part (14) can be selected along the height of the secured part (13). The height adjustment mechanism (15) is a structure for setting, as appropriate, the engagement combination of a first protrusion (29) and a second protrusion (30) to adjust the height position.

### TECHNICAL FIELD

The present invention relates to a clamp configured to fix a wire to an attachment object, and a wire harness.

### BACKGROUND

Conventionally, various electric/electronic components are mounted in a vehicle, and these electric/electronic components are electrically connected by a wire harness. In general, a wire harness of this type is attached to an attachment object such as a vehicle body via a plurality of clamps, for example, as described in Patent Document 1, and so forth.

### PRIOR ART DOCUMENT

### Patent Document

Patent Document 1: JP 2015-082870 A

### SUMMARY OF THE INVENTION

### Problems to be Solved

Meanwhile, wire harnesses have dimensional tolerances. A long tolerance generated between clamps may result in an excess length. If a wire harness has an excess length, wires may come into contact with an attachment object such as a vehicle body, for example, when vibration occurs in the wire harness. This leads to the problems of hammering sound and external wire damage, and therefore some sort of measures need to be taken.

An object of the present disclosure is to provide a clamp and a wire harness that can mitigate contact of a wire with an attachment object.

### Means to Solve the Problem

A clamp that solves the above-described problem is a configuration configured to fix a wire to an attachment object, including: a fixing part configured to be fixed to the attachment object; and a holding part configured to hold the wire at a selected position of the fixing part in a height direction of the fixing part.

A wire harness that solves the above-described problem is a configuration including: a wire; and a clamp configured to fix the wire to an attachment object, wherein the clamp includes: a fixing part configured to be fixed to the attachment object; and a holding part configured to hold the wire at a selected position of the fixing part in a height direction of the fixing part.

### Effect of the Invention

According to the present disclosure, it is possible to mitigate contact of a wire with an attachment object.

### BRIEF DESCRIPTION OF THE DRAWINGS

FIG. 1 is a schematic diagram showing an attached state of a wire harness according to an embodiment.

FIG. 2 is a perspective view of a clamp.

FIG. 3 is an exploded perspective view of the clamp.

FIG. 4 is a cross-sectional view taken along the line IV-IV in FIG. 3.

FIG. 5 is a cross-sectional view taken along the line V-V in FIG. 3.

FIG. 6 is a side view of a fixing part.

FIG. 7 is a front view of the fixing part.

FIGS. 8A to 8D are diagrams showing processes performed when a holding part is mounted to the fixing part.

FIG. 9 is a schematic diagram showing a wire before an excess length thereof is absorbed.

FIG. 10 is a schematic diagram showing the wire when the excess length thereof is absorbed by pulling up the holding part.

FIGS. 11A to 11C are diagrams showing processes performed when causing the holding part to return to the original height.

### DETAILED DESCRIPTION TO EXECUTE THE INVENTION

First, aspects of the present disclosure will be listed and described.
[1] A clamp according to the present disclosure is a configuration configured to fix a wire to an attachment object, including: a fixing part configured to be fixed to the attachment object; and a holding part configured to hold the wire at a selected position of the fixing part in a height direction of the fixing part.

With the configuration of the present example, when the wire is attached to the attachment object using the clamp, the wire is held by the holding part at the selected position that is selected so as to absorb the excess length of the wire. Thus, the wire is spaced away from the attachment object. Accordingly, it is possible to mitigate contact of the wire with the attachment object.
[2] The clamp further includes a height adjustment mechanism configured to attach the holding part to the fixing part at a selectable position in the height direction of the fixing part. With this configuration, it is possible to absorb the excess length of the wire by performing a simple operation of adjusting the position in the height direction of the holding part that holds the wire.
[3] The height adjustment mechanism adjusts a height of the wire relative to the fixing part in a stepwise manner. With this configuration, it is possible to easily adjust the height of the wire by moving the holding part by a preset amount.
[4] The height adjustment mechanism includes a releasing part configured to, when the holding part is excessively raised in the height direction, release positional holding provided by the height adjustment mechanism, thereby enabling the holding part to be lowered in the height direction. With this configuration, even if the wire is excessively raised, it is possible to adjust the position of the wire by releasing positional holding for the wire via the releasing part to reduce the height of the wire. Accordingly, the height of the wire can be set to a suitable position.
[5] The height adjustment mechanism holds a position of the holding part in the height direction by causing a first projection provided on the holding part to be engaged with a second projection that is a constituent of a group of projections provided on the fixing part. With this configuration, the holding part whose position has been adjusted in the height direction is held through engagement between the first projection and the second projection, and it is thus possible to firmly hold the height position.
[6] The releasing part that causes the holding part to return to an original height thereof is a plate spring part configured to bias the first projection in a direction in which the first projection is pressed against the second projection. With this configuration, it is possible to construct the releasing part with a simple structure using the plate spring.
[7] The fixing part includes a rail part on which a plurality of the second projections are arrayed. The position of the holding part in the height direction is adjusted by the holding part being moved along the rail part. With this configuration, it is possible to smoothly move the holding part along the rail part when adjusting the height of the wire. Accordingly, it is possible to improve the workability of adjustment of the height of the wire.
[8] The holding part has an annular shape. With this configuration, the holding part is attached to the fixing part such that the annular holding part is fitted to the fixing part. Accordingly, the holding part can be mounted to the fixing part using a structure that is less likely to be dislodged from the fixing part.
[9] The holding part includes a sliding surface configured to slide with the fixing part when the holding part is moved for height adjustment, the sliding surface being provided on an inner circumferential surface opposed to the fixing part, in at least a part of a portion of the inner circumferential surface where the first projection is not formed. With this configuration, it is possible to smoothly move the holding part relative to the fixing part while the sliding surface of the holding part is supported by the fixing part.
[10] The fixing part includes a recess through which the first projection is passed before the first projection is engaged with the second projection when the holding part is attached. With this configuration, the holding part can be smoothly mounted to the fixing part, while movement of the first projection when inserting the holding part into the fixing part is guided along the recess.
[11] The fixing part includes a rotation allowing part configured to, when the holding part is moved to a lower end of the recess, enable the holding part to be rotated about an axis relative to the fixing part until the first projection is aligned with an array of the second projections. With this configuration, the holding part can be smoothly rotated along the rotation allowing part when the first projection of the holding part that has been inserted into the fixing part is aligned with an array of the second projections. Accordingly, it is possible to improve workability when mounting the holding part to the fixing part.
[12] A wire harness according to the present disclosure is a configuration including: a wire; and a clamp configured to fix the wire to an attachment object, wherein the clamp includes: a fixing part configured to be fixed to the attachment object; and a holding part configured to hold the wire at a selected position of the fixing part in a height direction of the fixing part. With this configuration, it is possible to achieve the same operation and effects as those achieved by the above-described clamp.

### Details of Embodiments of the Present Disclosure

Specific examples of the clamp and the wire harness according to the present disclosure will be described below with reference to the drawings. It should be noted that the present invention is not limited to these examples, but is defined by the claims, and is intended to include all modifications which fall within the scope of the claims and the meaning and scope of equivalents thereof. In the drawings, portions of configurations may be exaggerated or simplified for convenience of description. In addition, the dimensional ratios of the components may be different from the actual ratios.

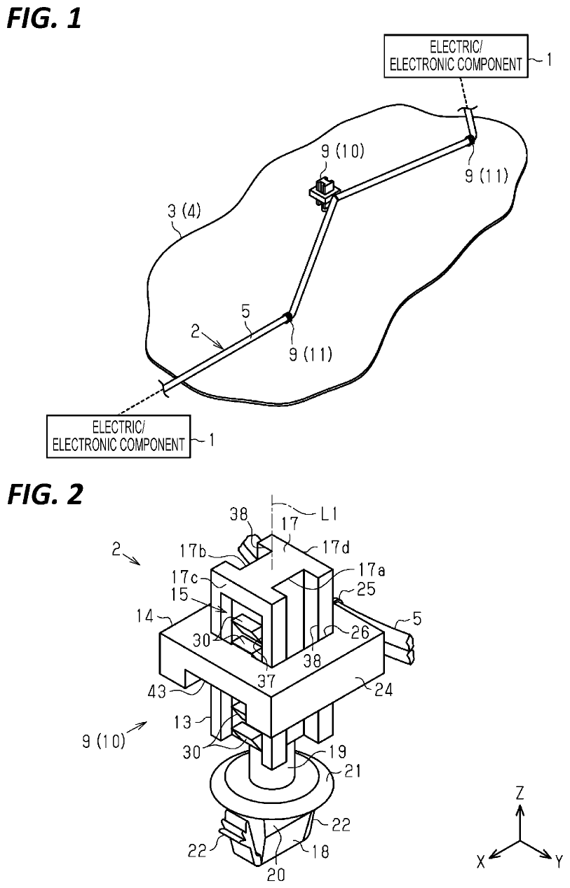

As shown in FIG. 1, a wire harness 2 that electrically connects electric/electronic components 1 of a vehicle to a power supply and an Electronic Control Unit (ECU) is attached and fixed to an attachment object 3 provided in the vehicle. The attachment object 3 is a vehicle door 4, for example. The wire harness 2 includes one or more wires 5 that conduct electricity. Each wire 5 is electrically connected to an electric/electronic component 1 via a connector (not shown) provided on the attachment object 3. The electric/electronic component 1 is a door lock device, any of various motors, or a speaker, for example.

The wire harness 2 includes a plurality of wire fixing parts 9 that attach and fix the wire 5 to the attachment object 3. In this manner, the wire 5 of the present example is attached and fixed to the attachment object 3 via the plurality of wire fixing parts 9. When a plurality of wire fixing parts 9 are provided, adjacent wire fixing parts 9 may be equidistantly or non-equidistantly spaced from each other.

The wire fixing parts 9 each include an excess length absorbing clamp (hereinafter simply referred to as a clamp 10) capable of adjusting a surplus length (hereinafter also referred to as an excess length) of the wire 5, or a versatile clamp 11 that does not have the function of absorbing an excess length of the wire 5. For example, the clamp 10 is disposed spotwise at a location where the excess length of the wire 5 is to be absorbed. For example, various members can be used as the versatile clamp 11 as long as they are clamps having a structure or a shape that can be fixed to the attachment object 3 with the wire 5 attached thereto.

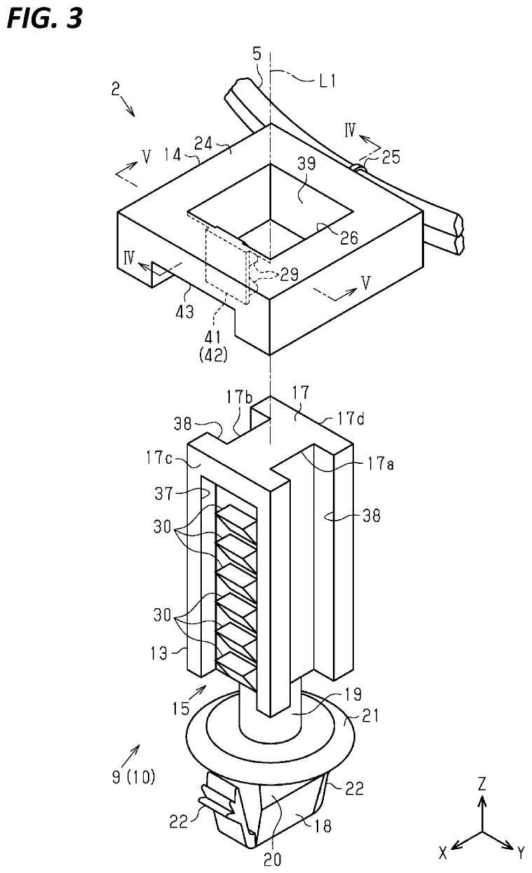

As shown in FIGS. 2 and 3, the clamp 10 includes a fixing part 13 configured to be fixed to the attachment object 3, and a holding part 14 configured to hold the wire 5 at a selected position of the fixing part 13 in the height direction (the Z-axis direction in FIGS. 2 and 3) of the fixing part 13. The clamp 10 of the present example includes a height adjustment mechanism 15 configured to attach the holding part 14 to the fixing part 13 at a selectable position in the height direction of the fixing part 13. The height adjustment mechanism 15 of the present example adjusts the height of the wire 5 relative to the fixing part 13 in a stepwise manner.

The fixing part 13 includes a main body part 17 serving as a portion where the holding part 14 is mounted, a coupling part 18 serving as a portion to be fixed to the attachment object 3, and a rotation allowing part 19 that couples the main body part 17 and the coupling part 18 to each other. The main body part 17 has a columnar shape. The main body part 17 of the present example has four side surfaces (wall surfaces), which in the case of the present example are referred to as a first side surface 17a, a second side surface 17b, a third side surface 17c, and a fourth side surface 17d. In the case of the present example, the first side surface 17a and the second side surface 17b are opposed to each other, and the third side surface 17c and the fourth side surface 17d are opposed to each other.

The coupling part 18 includes a coupling main body 20, a flange part 21 for fixing the fixing part 13 to the attachment object 3, and at least one projecting piece 22 for fixing the fixing part 13 to the attachment object 3 in cooperation with the flange part 21. The coupling main body 20 is disposed on a back surface of the flange part 21, and has a rectangular shape (a substantially rectangular parallelepiped shape), for example. The flange part 21 is a suction cup-like member, for example. For example, a plurality of projecting pieces 22 are provided. In the case where two projecting pieces 22 are provided, they are disposed at positions opposed to each other with the coupling main body 20 interposed therebetween. Each of the projecting pieces 22 is disposed such that a base thereof is coupled to the coupling main body 20, and a tip thereof is opposed to the flange part 21.

The holding part 14 includes a main body part 24 serving as a portion to be mounted to the fixing part 13, and a wire attachment part 25 to which the wire 5 is attached. For example, the wire attachment part 25 is preferably a band member such as a cable tie. The number of wires 5 attached to the wire attachment part 25 may be either one, or more than one. In the latter case, the number of wires 5 is not limited to two as illustrated in the drawing, and may be three or more. The holding part 14 constitutes a structure separate from the fixing part 13, and is configured to be mounted in one piece to the fixing part 13. For example, the holding part 14 (specifically, the main body part 24) has an annular shape configured to be fitted onto the fixing part 13. In this case, the columnar main body part 17 of the fixing part 13 is passed through an opening 26 of the holding part 14.

The height adjustment mechanism 15 includes at least one first projection 29 (see FIG. 3) provided on the holding part 14, and at least one second projection 30 provided on the fixing part 13. A plurality of (two in the present example) first projections 29 are provided on the holding part 14 in the thickness direction thereof. A plurality of second projections 30 are disposed on the third side surface 17c of the fixing part 13 in the height direction of the fixing part 13. In this manner, the height adjustment mechanism 15 of the present example is a structure that holds the position of the holding part 14 in the height direction by causing each first projection 29 of the holding part 14 to be engaged with a specific second projection 30 of a group of projections provided on the fixing part 13.

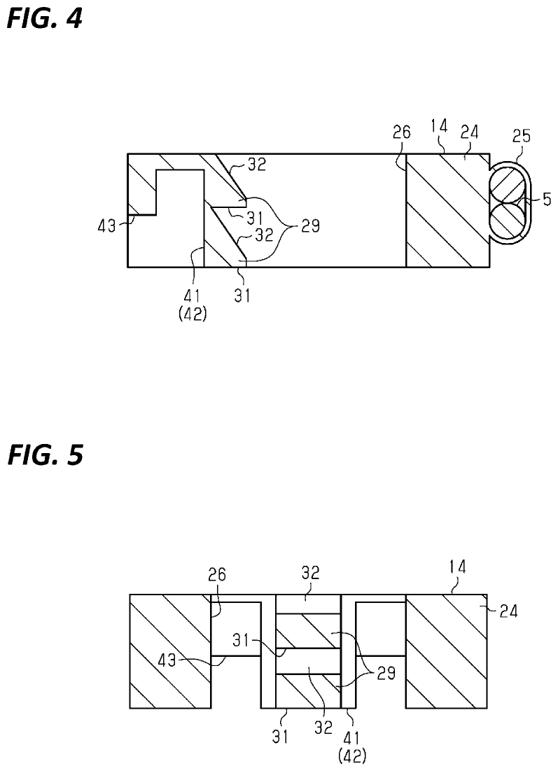

As shown in FIGS. 4 and 5, each of the first projections 29 is disposed on an inner circumferential surface of the opening 26 of the holding part 14. Each of the first projections 29 includes a planar engagement surface 31 configured to be engaged with a second projection 30, and an inclined surface 32, which is a surface downwardly inclined in the height direction of the fixing part 13. The inclined surface 32 allows movement of the holding part 14 when the holding part 14 is raised upward in the height direction.

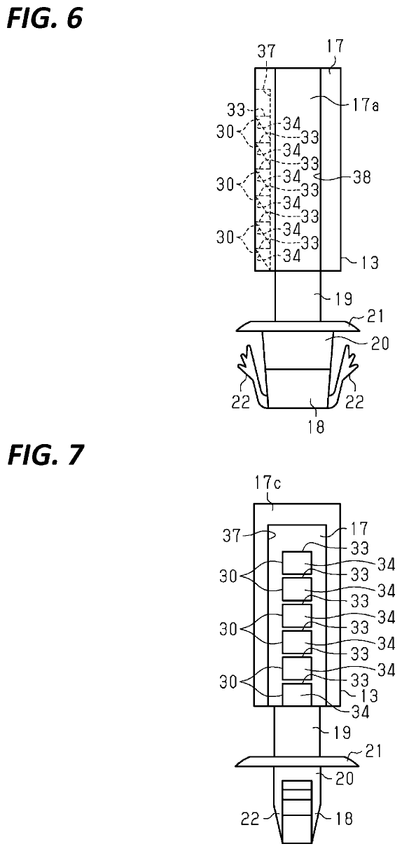

As shown in FIGS. 6 and 7, each of the second projections 30 includes a planar engagement surface 33 configured to be engaged with a first projection 29, and an inclined surface 34, which is a surface upwardly inclined in the height direction of the fixing part 13. The inclined surface 34 allows movement of the holding part 14 when the holding part 14 is raised upward in the height direction, in cooperation with the inclined surface 32 of the first projection 29.

A rail part 37 that extends in the height direction of the fixing part 13 is provided on the third side surface 17c of the main body part 17 of the fixing part 13, and a plurality of second projections 30 are disposed on the rail part 37. In this manner, the fixing part 13 includes a rail part 37 on which a plurality of second projections 30 are arrayed. The position of the holding part 14 in the height direction is adjusted by the holding part 14 being moved along the rail part 37.

As shown in FIGS. 2 and 3, the holding part 14 is inserted from above into the main body part 17 of the fixing part 13 when being attached to the fixing part 13. The fixing part 13 includes at least one recess 38 through which the first projection 29 is passed before the first projection 29 is engaged with the second projection 30 when the holding part 14 is attached. The recesses 38 of the present example are provided on both the first side surface 17a and the second side surface 17b of the main body part 17 of the fixing part 13. Accordingly, the main body part 17 of the fixing part 13 has a substantially H-shaped cross section.

The holding part 14 includes a sliding surface 39 (see FIG. 3) configured to slide with the fixing part 13 when the holding part 14 is moved for height adjustment, the sliding surface 39 being provided on an inner circumferential surface opposed to the fixing part 13, in at least a part of a portion of the inner circumferential surface where the first projection 29 is not formed. The sliding surface 39 of the present example includes a surface that comes into contact with the first side surface 17a, second side surface 17b, and fourth side surface 17d of the fixing part 13, for example. The sliding surface 39 slides with the fixing part 13 when the holding part 14 is slidably moved in a vertical direction relative to the fixing part 13.

The rotation allowing part 19 has, for example, a columnar shape that extends in the height direction of the fixing part 13. The rotation allowing part 19 is configured to, when the holding part 14 is moved to a lower end of the recess 38, enable the holding part 14 to be rotated about an axis L1 relative to the fixing part 13 until the first projection 29 is aligned with the rail part 37. The fixing part 13, the holding part 14, and the rotation allowing part 19 are disposed coaxially.

As shown in FIGS. 4 and 5, the height adjustment mechanism 15 includes a releasing part 41 configured to release, when the holding part 14 is excessively raised in the height direction, release positional holding provided by the height adjustment mechanism 15, thereby enabling the holding part 14 to be lowered in the height direction. In the case of the present example, the releasing part 41 is a plate spring part 42 configured to bias the first projection 29 in a direction in which the first projection 29 is pressed against the second projection 30. The holding part 14 includes a cut-out part 43 provided as an operation space for bending the plate spring part 42 in a direction opposite to the biasing direction.

Next, operations of the wire harness 2 and the clamp 10 of the present embodiment will be described.

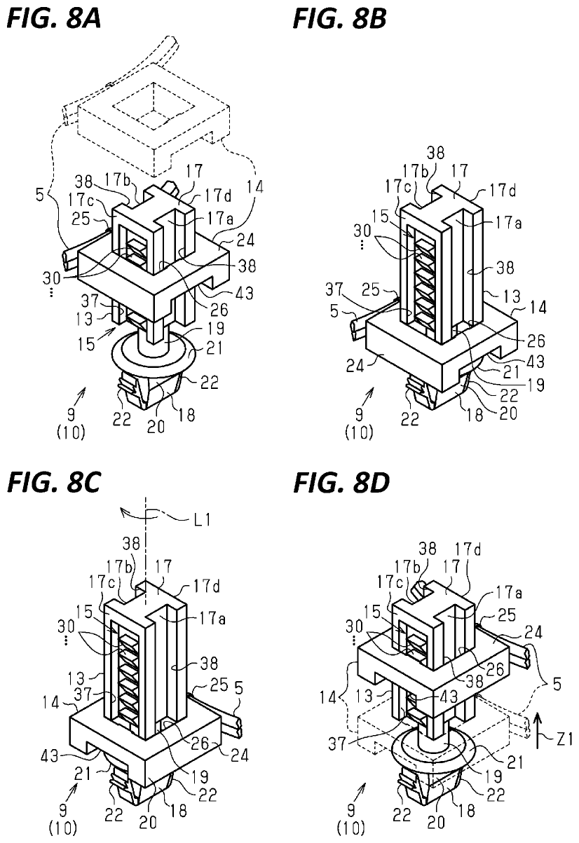

As shown in FIG. 8A, the wire 5 is attached to the wire attachment part 25 of the first, holding part 14, and the holding part 14 integrated in one piece with the wire 5 is inserted into the main body part 17 of the fixing part 13. At this time, the first projection 29 of the holding part 14 is aligned with the recess 38 of the fixing part 13, and the holding part 14 is inserted into the main body part 17 of the fixing part 13 along the recess 38. The holding part 14 can be smoothly inserted downward as a result of the first projection 29 being guided by the recess 38.

As shown in FIG. 8B, the holding part 14 that has been inserted into the main body part 17 of the fixing part 13 is inserted to the lowermost position of the main body part 17. That is, the holding part 14 is inserted deep to the position of the rotation allowing part 19.

As shown in FIG. 8C, after the holding part 14 has been inserted to the rotation allowing part 19, the holding part 14 at this position is rotated about the axis L1, to align the first projection 29 of the holding part 14 with the rail part 37 of the fixing part 13. In the case of the present example, the holding part 14 is rotated by 90 degrees in the clockwise direction on the plane of paper, to align the first projection 29 of the holding part 14 with the rail part 37 of the fixing part 13.

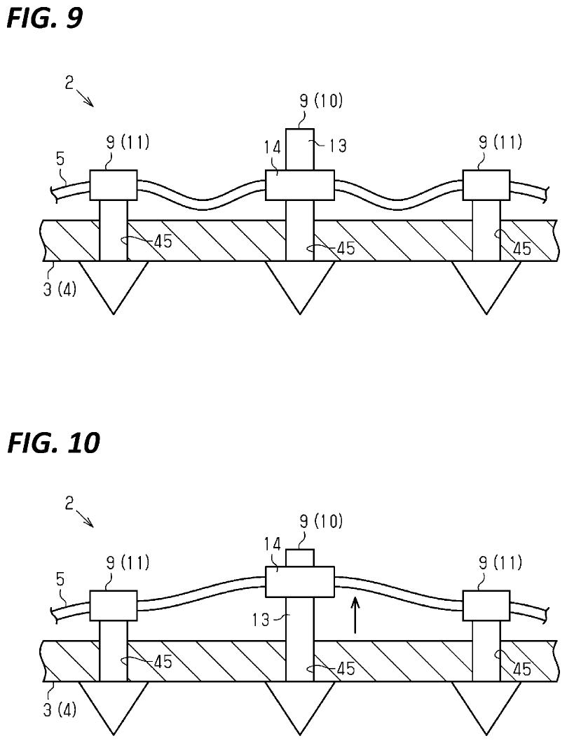

Subsequently, although not shown, the versatile clamp 11 is attached to the wire 5, to achieve a state in which the clamp 10 and the versatile clamp 11 are mounted to the wire 5. Then, the clamp 10 and the versatile clamp 11 are mounted and fixed to the attachment object 3. In the case of the present example, the clamp 10 and the versatile clamp 11 are inserted into the corresponding holes 45 (see FIGS. 9 and 10) in the attachment object 3. For example, the holes 45 are preferably elongated holes conforming to the shape of the coupling main body 20 so as to prevent the fixing part 13 (coupling part 18) from being rotated.

As shown in FIG. 8D, after the clamp 10 and the versatile clamp 11 have been mounted to the attachment object 3, the holding part 14 is raised upward (the direction indicated by the arrow Z1 in FIG. 8D) along the rail part 37. At this time, the holding part 14 is raised to a position at which the wire 5 no longer has an excess length, and the first projection 29 of the holding part 14 and the second projection 30 of the fixing part 13 are engaged with each other at the height position at which the wire 5 has no excess length, thus holding the height position of the holding part 14. When the holding part 14 is raised, the inclined surface 32 of the first projection 29 rides on the second projection 30, and the plate spring part 42 is deformed so as to be bent as a basal portion thereof as a starting point, thus making it possible to smoothly raise the holding part 14.

Here, FIG. 9 shows a state in which the wire 5 has an excess length before the holding part 14 is raised. As shown in FIG. 9, the wire 5 may have an excess length caused, for example, by manufacturing tolerances or the like of the wire harness 2. In this case, the wire 5 loosens, and sags downward by its own weight. If the wire harness 2 has an excess length in this manner, the wire 5 may interfere with the attachment object 3, thus leading to hammering sound, or external wire damage.

On the other hand, in the case of the present example, as shown in FIG. 10, the excess length of the wire 5 is absorbed by the holding part 14 when the holding part 14 is raised until the wire 5 is stretched. At this time, the wire 5 is spaced from the attachment object 3. Accordingly, the wire harness 2 is less likely to interfere with the attachment object 3, thus increasing the effect of suppressing generation of hammering sound and external wire damage.

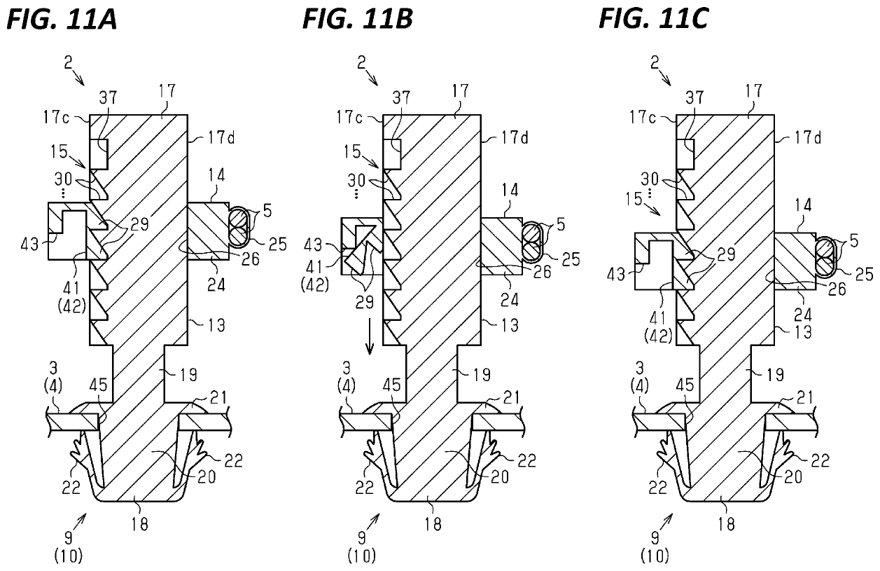

As shown in FIG. 11A, if the holding part 14 is excessively raised, first, a front end of the first projection 29 of the plate spring structure (releasing part 41) is pulled forward to disengage the first projection 29 and the second projection 30 from each other. Subsequently, as shown in FIGS. 11B and 11C, the holding part 14 is moved downward (the direction indicated by the arrow Z2 in FIG. 11B), and at a position at which the excessive pulling of the state wire 5 is eliminated, brings the first projection 29 back into engagement with the second projection 30 of the fixing part 13. As a result of the foregoing, the position of the holding part 14 relative to the fixing part 13 can be adjusted as appropriate.

With the wire harness 2 and the clamp 10 according to the above-described embodiment, the following effects can be achieved.
(1) A clamp 10 configured to fix a wire 5 to an attachment object 3 includes a fixing part 13 configured to be fixed to the attachment object 3, and a holding part 14 configured to hold the wire 5 at a selected position of the fixing part 13 in the height direction of the fixing part 13.

With the configuration of the present example, when the wire 5 is attached to the attachment object 3 using the clamp 10, the wire 5 is held by the holding part 14 at the selected position that is selected so as to absorb the excess length of the wire 5. Thus, the wire 5 is spaced away from the attachment object 3. Thus, it is possible to mitigate contact of the wire 5 with the attachment object 3.
(2) The clamp 10 includes a height adjustment mechanism 15 configured to attach the holding part 14 to the fixing part 13 at a selectable position in the height direction of the fixing part 13. With this configuration, it is possible to absorb the excess length of the wire 5 by performing a simple operation of adjusting the position in the height direction of the holding part 14 that holds the wire 5.
(3) The height adjustment mechanism 15 is a structure that can be set at various height positions. Accordingly, it is possible to absorb various excess lengths. In addition, the use of a single type of clamp 10 is sufficient regardless of the length or the among of excess length of the wire 5.
(4) The height adjustment mechanism 15 is a structure that adjusts the height position by appropriately setting a combination of engagement between the first projection 29 and the second projection 30. Accordingly, the height adjustment mechanism 15 can be a versatile structure.
(5) The height adjustment mechanism 15 adjusts the height of the wire 5 relative to the fixing part 13 in a stepwise manner. With this configuration, it is possible to easily adjust the height of the wire 5 by moving the holding part by a preset amount.
(6) The height adjustment mechanism 15 includes a releasing part 41 configured to, when the holding part 14 is excessively raised in the height direction, release positional holding provided by the height adjustment mechanism 15, thereby enabling the holding part 14 to be lowered in the height direction. With this configuration, even if the wire 5 is excessively raised, it is possible to adjust the position of the wire 5 by releasing positional holding for the wire 5 via the releasing part 41 to reduce the height. Accordingly, the height of the wire 5 can be set to a suitable position.
(7) The height adjustment mechanism 15 holds the position of the holding part 14 in the height direction by causing a first projection 29 provided on the holding part 14 to be engaged with a second projection 30 that is a constituent of a group of projections provided on the fixing part 13. With this configuration, the holding part 14 whose position has been adjusted in the height direction is held through engagement between the first projection 29 and the second projection 30, and it is thus possible to firmly hold the height position.
(8) The releasing part 41 that causes the holding part 14 to return to the original height is a plate spring part 42 configured to bias the first projection 29 in a direction in which the first projection 29 is pressed against the second projection 30. With this configuration, it is possible to construct the releasing part 41 with a simple structure using the plate spring.
(9) The fixing part 13 includes a rail part 37 on which a plurality of second projections 30 are arrayed. The position of the holding part 14 in the height direction is adjusted by the holding part 14 being moved along the rail part 37. With this configuration, it is possible to smoothly move the holding part 14 along the rail part 37 when adjusting the height of the wire 5. Accordingly, it is possible to improve the workability of adjustment of the height of the wire 5.
(10) The holding part 14 has an annular shape. With this configuration, the holding part 14 is attached to the fixing part 13 such that the annular holding part 14 is fitted to the fixing part 13. Accordingly, the holding part 14 can be mounted to the fixing part 13 using a structure that is less likely to be dislodged from the fixing part 13.
(11) The holding part 14 includes a sliding surface 39 configured to slide with the fixing part 13 when the holding part 14 is moved for height adjustment, the sliding surface 39 being provided on an inner circumferential surface opposed to the fixing part 13, in at least a part of a portion of the inner circumferential surface where the first projection 29 is not formed. With this configuration, it is possible to smoothly move the holding part 14 relative to the fixing part 13 while the sliding surface 39 of the holding part 14 is supported by the fixing part 13.
(12) The fixing part 13 includes a recess 38 through which the first projection 29 is passed before the first projection 29 is engaged with the second projection 30 when the holding part 14 is attached. With this configuration, the holding part 14 can be smoothly mounted to the fixing part 13, while movement of the first projection 29 when inserting the holding part 14 into the fixing part 13 is guided along the recess 38.
(13) The fixing part 13 includes a rotation allowing part 19 configured to, when the holding part 14 is moved to a lower end of the recess 38, enable the holding part 14 to be rotated about an axis L1 relative to the fixing part 13 until the first projection 29 is aligned with an array of the second projections. With this configuration, the holding part 14 can be smoothly rotated along the rotation allowing part 19 when the first projection 29 of the holding part 14 that has been inserted into the fixing part 13 is aligned with an array of the second projections 30. Accordingly, it is possible to improve workability when mounting the holding part 14 to the fixing part 13.

The present embodiment can be implemented with the following modifications. The present embodiment and the following modifications can be implemented in combination with each other as long as there are no technical discrepancies.

The fixing part 13 may include, at the termination of movement of the rail part 37, a stopper part that restricts movement of the holding part 14 in the height direction. In this case, the holding part 14 can be stopped at the termination of the rail part 37, thus restricting dislodgement from the fixing part 13. Note that the stopper part may be a member using the structure according to the example, or may have a shape obtained by newly forming a projection.

The height adjustment mechanism 15 may have one first projection 29.

The shapes of the first projection 29 and the second projection 30 are not limited to shapes having a triangular cross section, and may be any shapes that can be engaged with each other.

The height adjustment mechanism 15 is not limited to a mechanism configured to adjust a position in a stepwise manner, and may be a mechanism capable of successively setting positions.

The releasing part 41 is not limited to a plate spring structure (plate spring part 42), and may be any structure capable of releasing positional holding for the fixing part 13 and the holding part 14.

The shape of the rotation allowing part 19 is not limited to a columnar shape, and may be changed to other shapes such as a quadrangular prism shape.

The shape of the fixing part 13 may be changed to various shapes as long as the fixing part 13 can be fixed to the attachment object 3.

The holding part 14 is not limited to a structure that is inserted into the fixing part 13 so as to be lowered to the lowermost position, then is rotated at the lowermost point, and raised. For example, the holding part 14 may be a structure that is manufactured with its initial position located at the lowermost end, and is raised relative to the fixing part 13 during height position adjustment.

The shape of the holding part 14 is not limited to an annular shape, and may be changed to shapes other than an annular shape as long as the holding part 14 includes a mechanism capable of moving in the height direction relative to the fixing part 13.

A plurality of wires 5 having different diameters may be bundled.

The wire 5 may be a flat cable.

The wire 5 may be a wire whose circumference is covered with an insulating material or the like.

The fixing part 13 and the holding part 14 are not limited to being separate from each other, and may be formed in one piece.

The fixing part 13 may be provided with a plurality of stages of holding parts 14 having different heights, and the wire 5 may be attached to a position of the holding parts 14 at which an excess length can be absorbed, whereby the wire 5 may be spaced away from the attachment object 3.

The attachment object 3 is not limited to the vehicle door 4, and may be a vehicle-mounted component or a vehicle body.

The wire harness 2 is not limited to being mounted in a vehicle, and may be used for other devices and apparatuses.

The height adjustment mechanism 15 may be referred to as a ratchet or a linear ratchet. An array of the second projections 30 of the fixing part 13 of the embodiment may be referred to as a ratchet-type sliding rail. The recess 38 of the fixing part 13 of the embodiment may be referred as a ratchetless sliding rail or a free sliding rail. The array of the second projections 30 of the fixing part 13 may be provided at a position at a first predetermined angle of rotation about the longitudinal axis of the fixing part 13 or the main body part 17. The recess 38 of the fixing part 13 may be provided at a second predetermined angle of rotation about the longitudinal axis of the fixing part 13 or the main body part 17.

As shown in FIGS. 8A to 8D to FIG. 10, to adjust the distance between the attachment object 3 and the holding part 14 that holds the wire 5, the holding part 14 may be moved linearly relative to the elongated fixing part 13 and in only one direction, and the holding part 14 may be fixed to the fixing part 13 at a desired position.

The main body part 17 of the fixing part 13 of the embodiment may be referred to as a columnar part. As shown in FIGS. 3 and 11A to 11C, the main body part 17 may extend away from the attachment object 3.

The releasing part 41 of the holding part 14 of the embodiment may be referred to as a lock piece, and the main body part 24 of the holding part 14 may be referred to as a frame-shaped part. As shown in FIGS. 3 to 5 and 11A to 11C, the main body part 24 of the holding part 14 may be fitted onto the main body part 17 of the fixing part 13, and the releasing part 41 may extend from the main body part 24 in a cantilevered manner.

As shown in FIGS. 3 and 11A to 11C, the plurality of second projections 30 may be arranged in a direction in which the main body part 17 of the fixing part 13 extends. When the main body part 24 of the holding part 14 is fitted onto the main body part 17 of the fixing part 13, the first projections 29 and the second projections 30 face each other, and each of the first projections 29 may be fitted between adjacent second projections 30. With this configuration, the holding part 14 can be positioned by the first projections 29 and the second projections 30.

As shown in FIGS. 11A to 11C, when the holding part 14 is moved along the fixing part 13, the releasing part 41 may be elastically deformed in a direction orthogonal to the direction in which the main body part 17 extends, and the first projections 29 may be moved in a direction away from the second projections 30. With this configuration, the holding part 14 (wire 5) can be freely moved to a suitable position.

The inclined surfaces 34 of the second projections 30 may be formed such that the distance to the center of the main body part 17 increases in a direction away from the attachment object 3, and the inclined surfaces 32 of the first projections 29 may be formed so as to correspond to the inclined surfaces 34. With this configuration, the holding part 14 can be raised above the main body part 17.

As shown in FIGS. 3 and 8A to 8D, the recess 38 may be formed in a direction in which the main body part 17 extends, and the first projections 29 can be housed inside the recess 38. With this configuration, the holding part 14 can be smoothly inserted downward as a result of the first projections 29 being guide by the recess 38.

As shown in FIGS. 3, 8A to 8D and 11A to 11C, the rotation allowing part 19 of the fixing part 13 may have a smaller diameter than the main body part 17, and the first projection 29 can be housed inside the rotation allowing part 19. With this configuration, when the holding part 14 is moved to a lower end of the recess 38, the holding part 14 can be rotated relative to the fixing part 13 until the first projections 29 and the second projections 30 are aligned with each other.

The opening 26 of the holding part 14 of the embodiment may be referred to as a polygonal opening having a polygonal inner contour, and/or having a first maximum thickness.

The main body part 17 of the fixing part 13 of the embodiment prevents the holding part 14 from freely rotating about the longitudinal axis of the main body part 17, but may be configured to allow the holding part 14 to linearly reciprocate along the longitudinal axis of the main body part 17 only when the holding part 14 is at one or more positions at predetermined angles of rotation about the longitudinal axis of the fixing part 13. For example, the main body part 17 of the fixing part 13 may be a first polygonal linear column having a first polygonal outer contour that matches a polygonal inner contour of the opening 26 of the holding part 14, and/or having a second maximum thickness that matches a first maximum thickness.

The rotation allowing part 19 of the fixing part 13 of the embodiment allows the holding part 14 to freely rotate about the longitudinal axis of the rotation allowing part 19, but may be configured to prevent the holding part 14 from linearly reciprocate along the longitudinal axis of the main body part 17 unless the holding part 14 is at one or more positions at predetermined angles of rotation. For example, the rotation allowing part 19 of the fixing part 13 may be a second polygonal linear column having a second polygonal outer contour smaller than the polygonal inner contour of the opening 26 of the holding part 14, and/or having a third maximum thickness smaller than the first maximum thickness.

Although the present disclosure has been described pursuant to embodiments, it should be appreciated that the present disclosure is not limited to the embodiments and the structures thereof. The present disclosure encompasses various modifications, and modifications within the scope of equivalency thereof. In addition, various combinations and configurations, as well as other combinations and configurations, including more, less or only a single element, are also within the spirit and scope of the present disclosure.

### LIST OF REFERENCE NUMERALS

1 Electric/electronic component
2 Wire harness
3 Attachment object
4 Vehicle door
5 Wire
9 Wire fixing part
10 Clamp
11 Versatile clamp
13 Fixing part
14 Holding part
15 Height adjustment mechanism
17 Main body part
17a First side surface
17b Second side surface
17c Third side surface
17d Fourth side surface
18 Coupling part
19 Rotation allowing part
20 Coupling main body
21 Flange part
22 Projecting piece
24 Main body part
25 Wire attachment part
26 Opening
29 First projection
30 Second projection
31 Engagement surface
32 Inclined surface
33 Engagement surface
34 Inclined surface
37 Rail part
38 Recess
39 Sliding surface
41 Releasing part
42 Plate spring part
43 Cut-out part
45 Hole

1. A clamp configured to fix a wire to an attachment object, comprising:
a fixing part configured to be fixed to the attachment object; and
a holding part configured to hold the wire at a selected position of the fixing part in a height direction of the fixing part.

2. The clamp according to claim 1, further comprising a height adjustment mechanism configured to attach the holding part to the fixing part at a selectable position in the height direction of the fixing part.

3. The clamp according to claim 2,
wherein the height adjustment mechanism adjusts a height of the wire relative to the fixing part in a stepwise manner.

4. The clamp according to claim 2,
wherein the height adjustment mechanism includes a releasing part configured to, when the holding part is excessively raised in the height direction, release positional holding provided by the height adjustment mechanism, thereby enabling the holding part to be lowered in the height direction.

5. The clamp according to claim 2,
wherein the height adjustment mechanism holds a position of the holding part in the height direction by causing a first projection provided on the holding part to be engaged with a second projection that is a constituent of a group of projections provided on the fixing part.

6. The clamp according to claim 2,
wherein the height adjustment mechanism includes a releasing part configured to, when the holding part is excessively raised in the height direction, release positional holding provided by the height adjustment mechanism, thereby enabling the holding part to be lowered in the height direction,
the height adjustment mechanism holds a position of the holding part in the height direction by causing a first projection provided on the holding part to be engaged with a specific second projection of a group of projections provided on the fixing part, and
the releasing part is a plate spring part configured to bias the first projection in a direction in which the first projection is pressed against the second projection.

7. The clamp according to claim 5,
wherein the fixing part includes a rail part on which a plurality of the second projections are arrayed, and
the position of the holding part in the height direction is adjusted by the holding part being moved along the rail part.

8. The clamp according to claim 5,
wherein the holding part has an annular shape.

9. The clamp according to claim 8,
wherein the holding part includes a sliding surface configured to slide with the fixing part when the holding part is moved for height adjustment, the sliding surface being provided on an inner circumferential surface opposed to the fixing part, in at least a part of a portion of the inner circumferential surface where the first projection is not formed.

10. The clamp according to claim 5,
wherein the fixing part includes a recess through which the first projection is passed before the first projection is engaged with the second projection when the holding part is attached.

11. The clamp according to claim 10,
wherein the fixing part includes a rotation allowing part configured to, when the holding part is moved to a lower end of the recess, enable the holding part to be rotated about an axis relative to the fixing part until the first projection is aligned with an array of the second projections.

12. A wire harness comprising:
a wire; and
a clamp configured to fix the wire to an attachment object,
wherein the clamp includes:
a fixing part configured to be fixed to the attachment object; and
a holding part configured to hold the wire at a selected position of the fixing part in a height direction of the fixing part.
